(19) United States
(12) Patent Application Publication
(10) Pub. No.: US 2026/0037592 A1
(43) Pub. Date: Feb. 5, 2026

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventor: Tomoyuki SUZUKI, Shinagawa Tokyo (JP)

(73) Assignee: KABUSHIKI KAISHA TOSHIBA, Tokyo (JP)

(21) Appl. No.: 19/272,472

(22) Filed: Jul. 17, 2025

(30) Foreign Application Priority Data
Aug. 5, 2024 (JP) 2024-128724

(51) Int. Cl. G06F 17/11

(52) U.S. Cl. CPC G06F 17/11

(57) ABSTRACT

An information processing device includes a regression equation generation module and an estimation module. The regression equation generation module generates a regression equation that includes a plurality of input variables and a plurality of coefficients respectively corresponding to the plurality of input variables to obtain one or more output variables. The estimation module estimates a plurality of coefficients by using one or more correction values each of which corrects each of one or more target coefficients included in the plurality of coefficients, where the correction values is determined based on knowledge regarding the relationship between the input variable corresponding to the target coefficient and the output variable.

### CROSS-REFERENCE TO RELATED APPLICATIONS

This application is based upon and claims the benefit of priority from Japanese Patent Application No. 2024-128724, filed on Aug. 5, 2024; the entire contents of which are incorporated herein by reference.

### FIELD

Embodiments described herein relate generally to an information processing device, an information processing method, and a computer program product.

### BACKGROUND

Technologies for modeling physical phenomena are conventionally known. For example, there is a technology to apply a function identification problem, which is one type of machine learning, and to obtain a mathematical model that describes physical phenomena from time-series data.

### BRIEF DESCRIPTION OF THE DRAWINGS

FIG. 1 is a diagram illustrating a configuration example of a battery module;

FIG. 2 is a diagram illustrating an example of time-series data;

FIG. 3 is a diagram illustrating an example of a functional configuration of an information processing device;

FIG. 4 is a diagram illustrating an example of knowledge;

FIG. 5 is a flowchart of a method for generating a model;

FIG. 6 is a diagram illustrating how coefficients of a regression equation are estimated;

FIG. 7 is a diagram illustrating an example of knowledge provided between some variables; and

FIG. 8 is a hardware configuration diagram of an information processing device.

### DETAILED DESCRIPTION

According to an embodiment, an information processing device includes at least one hardware processor configured to function as a regression equation generation module, and an estimation module. The regression equation generation module generates a regression equation including a plurality of input variables and a plurality of coefficients respectively corresponding to the plurality of input variables to obtain one or more output variables. The estimation module estimates the plurality of coefficients by using one or more correction values each of which corrects each of one or more target coefficients included in the plurality of coefficients. Each of the correction values is determined based on knowledge regarding a relationship between an input variable corresponding to a target coefficient and an output variable.

Exemplary embodiments of an information processing device according to the present disclosure will be described in detail below with reference to the accompanying drawings. The present disclosure is not limited to the following embodiments.

An example of a method for generating a model of a physical phenomenon will be described. For example, assuming that the differential equation representing a model is expressed in the form of Formula (1) below, the model is generated by estimating coefficients ξ₁ to ξ₈.

$$\begin{matrix}{x}_{1} = {ξ}_{1} {x}_{1} + {ξ}_{2} {x}_{2} + {ξ}_{3} {z}_{1} + {ξ}_{4} {z}_{2} \\ {x}_{2} = {ξ}_{5} {x}_{1} + {ξ}_{6} {x}_{2} + {ξ}_{7} {z}_{1} + {ξ}_{8} {z}_{2}\end{matrix} \qquad ( 1 )$$

As a method for estimating the coefficients, for example, the sparse estimation technology is used to estimate each coefficient such that values of most coefficients become zero. For example, in Formula (1), the values of the coefficients ξ₁ to ξ₃ are estimated to be zero, while the value of the coefficient ξ₄ is estimated to be a non-zero value. This example means that the value of the variable on the left side (derivative value of x₁) is estimated from the value of the variable z₂. Such an estimation technology can be interpreted as a method for estimating the coefficients while selecting valid variables for the estimation (ze in the above example).

The variables x and z used for generating the model are, for example, variables included in time-series data obtained by measuring a modeling target. x is a dependent variable, and z is an independent variable. The dependent variable is a variable that is determined depending on the independent variable. The independent variable is a variable indicating a factor of a change in the dependent variable. The dependent variable is, for example, temperatures of an electronic component, heat sink, and the like. The independent variable is, for example, the wind speed indicating wind strength of a fan cooling an electronic component, pressure difference between an inlet and outlet of a cooling flow path, a current flowing through an electronic component, a voltage input to an electronic component, and the like.

Hereinafter, a variable that serves as input to the formula representing the model (variable included on the right side) may be referred to as an input variable, while a variable that serves as output of the formula (variable included on the left side) may be referred to as an output variable. For example, in Formula (1), the variables x and z correspond to the input variables, and the derivative value of the variable x corresponds to the output variable. In this way, the input variable may include not only the independent variable but also the dependent variable (variable x) or terms derived from the dependent variable.

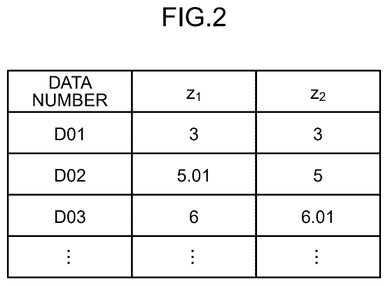

FIG. 2 is a diagram illustrating an example of time-series data. The data number is information that identifies data acquired at different times. The data number may be represented as time at which the data is acquired. FIG. 2 illustrates an example in which almost the same values are acquired as the variables z₁ and z₂ at each time. In such a case, similarly to the case where there is a relationship that can be expressed as a linear combination (multicollinearity) among multiple variables, it is difficult to estimate the coefficients of the variables z₁ and z₂ with high precision.

This will be further described with an example using the thermal network method for the modeling of physical phenomena. Note that the physical quantities and physical phenomena to be modeled are not limited to the heat transfer handled in the thermal network, but may include any other physical quantities. In the thermal network method, the energy conservation at each node is expressed by Formula (2) below.

$$\frac{{dT}_{n}}{dt} = \frac{1}{{C}_{n}} \{ {Q}_{n} + {\sum }_{\begin{matrix}j = 1 \\ j \neq n\end{matrix}}^{N} \frac{1}{{R}_{nj}} ( {T}_{j} - {T}_{n} ) \} \qquad ( 2 )$$

C is heat capacity, R is heat resistance, Q is calorific value, T is temperature, and N is the number of nodes. In Formula (2), for example, the calorific value Q corresponds to the independent variable z in Formula (1). The temperature difference (Tⱼ-Tₙ) corresponds to the dependent variable x in Formula (1). n is an integer that satisfies 1≤n≤N. j is an integer that satisfies 1≤j≤N and j≠n.

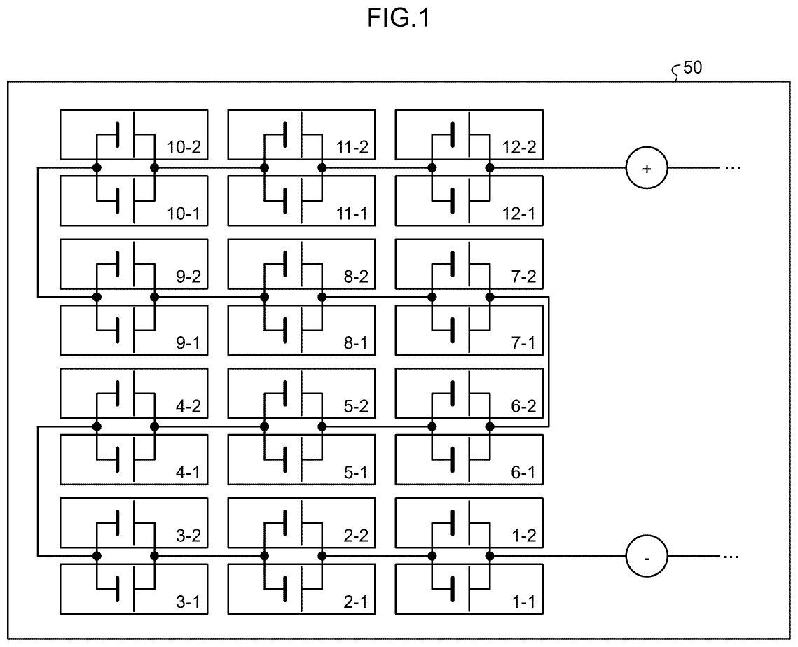

Thermal fluid analysis can target, for example, a battery module. FIG. 1 is a diagram illustrating a configuration example of a battery module 50. The battery module 50 has a configuration in which 12 battery cells, in each of which two battery cells are connected in parallel, are connected in series. For example, the battery cells c-1 and c-2 (where c ranges from 1 to 12) are two battery cells connected in parallel.

Using conventional methods, a thermal hydraulic analysis is performed on the battery module 50 by using time-series data as illustrated in FIG. 2, and the approximation formula for temperature prediction generated using results of the thermal hydraulic analysis (reduced order model: ROM, and the like) is represented by, for example, Formula (3) below.

$$\{ \begin{matrix}{\dot{T}}_{1 - 1} = … + 0.0015 {Q}_{1 - 2} \\ {\dot{T}}_{1 - 2} = … + 0.0016 {Q}_{1 - 1} \\ {\dot{T}}_{2 - 1} = … + 0.0016 {Q}_{1 - 2} \\ {\dot{T}}_{2 - 2} = … + 0.0016 {Q}_{1 - 1} \\ ⋮\end{matrix} \qquad ( 3 )$$

For example, the formula in the first line of Formula (3) represents that the derivative value of the temperature T1-1 of the battery cell 1-1 is related to the calorific value Q1-2 of the battery cell 1-2, and is estimated from the calorific value Q1-2. However, correctly speaking, the derivative value of the temperature T1-1 of the battery cell 1-1 is related to the calorific value Q1-1 of the same battery cell 1-1, and should be estimated from the calorific value Q1-1. One of the causes of such mismatch of the battery cells is that, as illustrated in FIG. 2, data that has almost the same values is obtained. Using Formula (3) generated in this way, it may not be possible to estimate the temperature for unknown input data with high precision.

Therefore, the information processing device of the embodiment estimates the coefficients of the formula by using a correction value determined based on prior knowledge regarding the relationship between the input variable (calorific value Q in the above example) and the output variable (temperature T in the above example) of the modeled formula (regression equation).

In the present embodiment, the coefficients are estimated using the sparse estimation technology. Estimation methods using the sparse estimation technology include the method TA to execute the estimation of coefficients and the selection of variables separately, and the method TB to execute the estimation of coefficients and the selection of variables together. The method TA includes the following methods.
recursive feature elimination (RFE) to sequentially eliminate unimportant features from the given set of feature amounts
sequential thresholded least-squares (STLS)
Methods described in Japanese Patent Application Laid-open No. 2022-167097, Japanese Patent Application Laid-open No. 2022-167093, and Japanese Patent Application Laid-open No. 2024-098397

Hereinafter, an example of executing the estimation of coefficients and the selection of variables separately, as in the method TA, will be mainly described. An example of executing the estimation of coefficients and the selection of variables together, as in the method TB, will be described in the modified example.

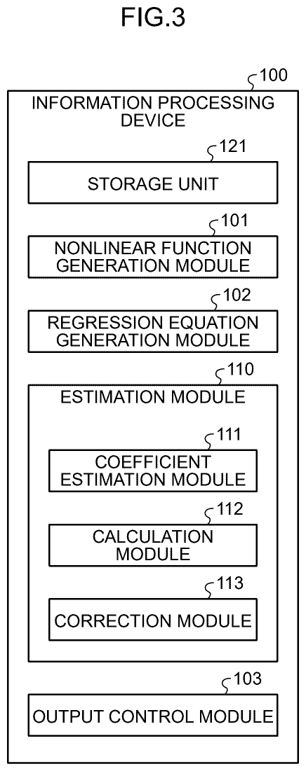

FIG. 3 is a diagram illustrating an example of a functional configuration of an information processing device 100 of the embodiment. The information processing device 100 of the embodiment includes a storage unit 121, a nonlinear function generation module 101, a regression equation generation module 102, an estimation module 110, and an output control module 103.

At least a part of the above units (nonlinear function generation module 101, regression equation generation module 102, estimation module 110, and output control module 103) may be implemented by one or more processing units. Each of the units is implemented, for example, by one or more processors. For example, each of the units may be implemented by causing a processor such as a central processing unit (CPU) and a graphics processing unit (GPU) to execute a program, that is, by software. Each of the units may be implemented by a processor such as a dedicated integrated circuit (IC), that is, by hardware. Each of the units may be implemented by using both software and hardware. When using a plurality of processors, each processor may implement one of the units or may implement two or more of the units.

The information processing device 100 may include a single device physically, or may include a plurality of devices physically. For example, the information processing device 100 may be constructed on a cloud environment. Each unit of the information processing device 100 may be distributed among a plurality of devices.

The storage unit 121 stores various pieces of information used by the information processing device 100. For example, the storage unit 121 stores time-series data including at least one of a dependent variable and an independent variable. In the information processing device 100 of the embodiment, the value of the dependent variable is represented in units unified for each physical quantity indicated by the dependent variable. For example, when the physical quantity is weight, the dependent variable represented by kg and the dependent variable represented by g are not mixed and unified into kg or g. Similarly, the value of the independent variable is represented in units unified for each physical quantity indicated by the independent variable.

Note that the storage unit 121 may store a plurality of types of time-series data. At least one of an initial condition and boundary condition may be different for the plurality of types of time-series data.

The storage unit 121 can include any commonly used storage medium, such as a flash memory, memory card, random access memory (RAM), hard disk drive (HDD), and optical discs.

The nonlinear function generation module 101 generates a nonlinear function based on at least one of the dependent variable and the independent variable. The nonlinear function generation module 101 generates the nonlinear function, for example, based on the temperature Tₙ at position n and the temperature Tⱼ at the position j. Position n and position j correspond to, for example, any of the N nodes. The nonlinear function generation module 101 may generate a plurality of nonlinear functions by a plurality of methods (for example, Japanese Patent Application Laid-open No. 2024-098397).

The regression equation generation module 102 generates a regression equation that includes a plurality of input variables and a plurality of coefficients respectively corresponding to the plurality of input variables to obtain one or more output variables. For example, the regression equation generation module 102 mixes the nonlinear functions generated by the nonlinear function generation module 101, and generates a linear regression equation used as a basis function.

Formula (4) below shows an example of the generated linear regression equation. Formula (4) is an example of a formula generated as a formula corresponding to Formula (2) described above.

$$\begin{matrix}\frac{dT}{dt} = {ξ}_{n , 0} {Q}_{1} + … + [ {ξ}_{n , p} {h}_{p} + {ξ}_{n , p + 1} {h}_{p + 1} + … ] ( {T}_{1} - {T}_{n} ) + \\ … + [ … + {ξ}_{n , p - 1} {h}_{p - 1} + {ξ}_{n , p} {h}_{n , p} ] ( {T}_{N} - {T}_{n} )\end{matrix} \qquad ( 4 )$$

In Formula (4), the input variables are the calorific value Q and hₚ (Tⱼ−Tₙ). The output variable is the derivative value of the variable Tₙ. hₚ represents a nonlinear function. P represents the number of candidates for the basis function. hₚ (Tⱼ−Tₙ) corresponds to a candidate for the basis function. Hereinafter, the candidate for the basis function may be represented as θ_{n,p}\hat{ }(t_{l, m}). “n, p” is a subscript to represent the pth candidate for the basis function at node n. t_{l,m} represents time. l represents the type of time-series data. For example, when a plurality of types of time-series data is used, the plurality of types of time-series data is distinguished by l. m corresponds to the data number within the time-series data. For example, if the time-series data in FIG. 2 is time-series data of type l, then t_{l, D01} represents the time corresponding to the data number “D01”. ξ_{n,p} represents the coefficient corresponding to the pth candidate for the basis function at node n.

The estimation module 110 estimates a plurality of coefficients by using a correction value determined based on knowledge of the relationship between the input variable corresponding to one or more coefficients to be corrected (hereinafter, target coefficients) and the output variable. The correction value is a value for correcting the corresponding target coefficient. The estimation module 110 includes a coefficient estimation module 111, a calculation module 112, and a correction module 113.

The coefficient estimation module 111 estimates the coefficients of the linear regression equation generated by the regression equation generation module 102 by machine learning that uses the time derivative value and the difference as learning data. The coefficient estimation module 111 may estimate the coefficient of the linear regression equation by the machine learning using a value indicating the short-term component (for example, time derivative value) and the difference indicating the long-term component (for example, difference indicating the fluctuation from the initial value of the variable) as learning data (for example, Japanese Patent Application Laid-open No. 2024-098397).

The calculation module 112 calculates the degree of influence based on the magnitude of the term (coefficient x basis function). The value of the basis function (for example, Tₙ−Tⱼ) changes over time. Therefore, the maximum value in the time-series data is regarded as a representative value of the basis function, specifically, the degree of influence is expressed as: magnitude of term=coefficient ξ_{n,p}×representative value of basis function. That is, the calculation module 112 calculates the product of the coefficient estimated by the coefficient estimation module 111 and the maximum value of the basis function corresponding to the coefficient as the degree of influence. The calculation module 112 may calculate the degree of influence by using the nonlinear function generated by any one of the plurality of methods (for example, Japanese Patent Application Laid-open No. 2024-098397).

Formula (5) below is a formula indicating an example of calculating the representative value (maximum value) of the basis function.

$${max}_{{t}_{l , m}} \vert {θ}_{n , p}^{( {t}_{l , m} )} \vert \qquad ( 5 )$$

Note that the representative value is not limited to the maximum value denoted in Formula (5) and may be any other value. For example, the representative value may be the root mean square (RMS) and standard deviation such as a Z-score.

Furthermore, in the present embodiment, the calculation module 112 calculates the degree of influence corrected with the correction value α for the target coefficient among the plurality of coefficients of the linear regression equation. The correction value α is determined based on knowledge (prior knowledge, prior information) about the relationship between the input variable corresponding to the target coefficient and the output variable.

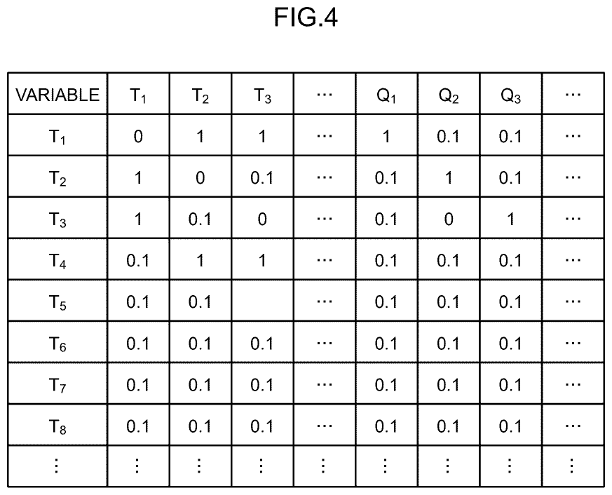

FIG. 4 is a diagram illustrating an example of knowledge. FIG. 4 is an example in which, for each temperature T (T₁ to T₈, and the like) corresponding to the output variable, a value indicating the degree of relationship with the temperature T and the calorific value Q corresponding to the input variables is set as knowledge. A larger value indicates a greater degree of relationship.

For example, the temperature T₁ represents the temperature at the node corresponding to the number “1”. The calorific value Q₁ represents the calorific value at the node corresponding to the number “1”. FIG. 4 illustrates, for example, that the temperature T₁ has a high degree of relationship with the temperature T₂, the temperature T₃, and the calorific value Q₁. Note that between the same variables (for example, temperature T₁ and temperature T₁), the value of zero is set.

Hereinafter, the correction value α for the coefficient ξ_{n, p} is represented as α_{n, p}. The correction value α_{n, p} may be set to the same value for each group to which the corresponding coefficient ξ_{n, p} belongs. This will be described by using an example for the second row (T₂) and third column (T₃) in FIG. 4. The value in the second row and third column of FIG. 4 is 0.1. The second row and third column corresponds to, for example, the term of (ξ₂, pₕp+ξ₂, ₚ₊₁hₚ₊₁+ . . . ) (T₃−T₂) on the right side of Formula (4). The group is a group of coefficients included in the former parentheses ( ) In this example, the values of the correction values α_{2, p}, α_{2, p+1}, . . . corresponding to the coefficients ξ_{2, p}, ξ_{2, p+1}, . . . included in the group are the common value of 0.1.

The correction value α is set to a larger value as the degree of relationship between the input variable and the output variable corresponding to the target coefficient increases. For example, the correction value α may be a real number between 0 and 1 inclusive. The maximum value of the correction value α is not limited to 1, and may be a value greater than 1, for example. Note that the correction value of the coefficient corresponding to the variable for which knowledge cannot be obtained may be set to a fixed value (for example, 1). In this case, the correction value (fixed value) is set for coefficients other than the target coefficient.

The representation of knowledge is not limited to FIG. 4, nor is the method for setting the correction value based on knowledge limited to the above method. Any method may be used if the method is to set the correction value based on knowledge that can be obtained in advance regarding the relationship between the input variable and the output variable. The correction value itself for each coefficient may be provided as knowledge.

Returning to the description of FIG. 3. The correction module 113 corrects the coefficient based on the degree of influence calculated by the calculation module 112. For example, the correction module 113 corrects the coefficient of the basis function with the degree of influence equal to or less than a threshold to 0 (zero). At this time, when learning is executed with data that is a mixture of data that has undergone different preprocessing (when a plurality of nonlinear functions is generated by a plurality of methods), the correction module 113 may target (either) one data before the mixture as the representative value of the basis function candidate in the magnitude of the term (for example, Japanese Patent Application Laid-open No. 2024-098397).

For example, the correction module 113 corrects the coefficient ξ_{n,p} to zero when Formula (6) or Formula (7) below is satisfied. λₙ is a hyperparameter defined for each node n, and λₙ<1. The right side of Formula (6) or Formula (7) corresponds to the threshold.

$${α}_{n , p} {ξ}_{n , p} {max}_{{t}_{l , m}} \vert {θ}_{n , p}^{( {t}_{l , m} )} \vert \leq {λ}_{n} \times {\sum }_{p} ( {α}_{n , p} {ξ}_{n , p} {max}_{{t}_{l , m}} \vert {θ}_{n , p}^{( {t}_{l , m} )} \vert ) \qquad ( 6 )$$

$${α}_{n , p} {ξ}_{n , p} {max}_{{t}_{l , m}} \vert {θ}_{n , p}^{( {t}_{l , m} )} \vert \leq {λ}_{n} \times {max}_{p} ( {α}_{n , p} {ξ}_{n , p} {max}_{{t}_{l , m}} \vert {θ}_{n , p}^{( {t}_{l , m} )} \vert ) \qquad ( 7 )$$

As described above, the correction value α is set to a larger value as the degree of relationship between the input variable and the output variable corresponding to the target coefficient increases. As denoted in Formula (6) and Formula (7), the threshold used for the determination to set the value of the coefficient to zero increases as the value of the correction value α increases. Therefore, as the degree of relationship increases, the possibility that the coefficient will not be zero, that is, the corresponding variable will be selected increases.

Therefore, even in a situation as described in FIG. 2, where almost the same values are acquired for different variables, if the appropriate correction values are set based on knowledge, it becomes possible to select the more appropriate variable and estimate the coefficient with higher precision.

The method using Formula (6) or Formula (7) can be interpreted as a method for controlling the selection of the variable (basis function) by correcting the threshold with the correction value α. The selection of variables may be controlled by correcting the coefficient with the correction value α. For example, the correction module 113 may correct the coefficient ξ_{n,p} to zero when Formula (8) below is satisfied. λ is a hyperparameter that is commonly defined across a plurality of nodes, and λ<1.

$${α}_{n , p} {ξ}_{n , p} < λ \qquad ( 8 )$$

When a convergence condition is satisfied, the output control module 103 outputs the linear regression equation represented with the corrected coefficient. The convergence condition is, for example, the number of iterations of the machine learning process and the like. The output control module 103 may display the linear regression equation on a display device.

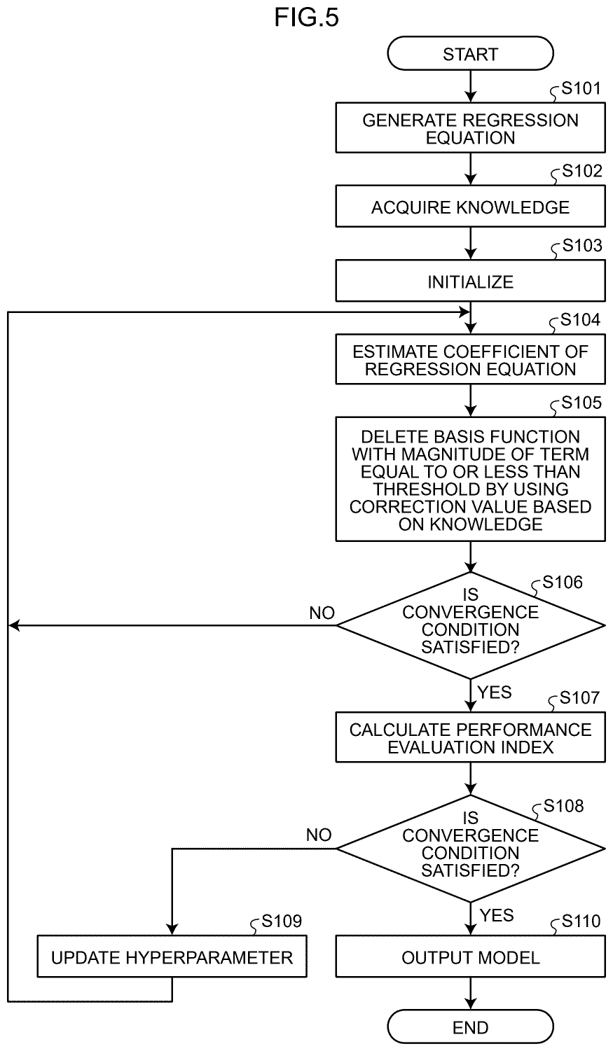

Next, the process of generating a model by the information processing device 100 will be described. FIG. 5 is a flowchart illustrating an example of a method for generating a model of the embodiment.

The regression equation generation module 102 mixes the nonlinear functions generated by the nonlinear function generation module 101, and generates a linear regression equation used as a basis function (step S101).

The estimation module 110 acquires knowledge obtained in advance regarding the relationship between the input variable and the output variable (step S102). The estimation module 110 may hereafter calculate the correction value for each coefficient by using the knowledge acquired.

The estimation module 110 initializes data to be used when executing machine learning on the model (for example, hyperparameters and the like) (step S103).

Next, the coefficient estimation module 111 estimates the coefficient of the linear regression equation generated by the regression equation generation module 102 (step S104). The method for estimating the coefficient can be any method, and for example, a method for estimation using the non-negative least squares method can be applied.

Next, the calculation module 112 calculates the above-described degree of influence (magnitude of term) by using the correction value based on knowledge, and the correction module 113 corrects the coefficient of the basis function with the degree of influence equal to or less than the threshold to zero, thereby deleting the basis function equal to or less than the threshold (step S105). For example, the correction module 113 corrects the coefficient of the basis function with the degree of influence equal to or less than the threshold to zero, as denoted in Formula (6) or (7) described above.

Next, the correction module 113 determines whether results of the coefficient estimation and correction process satisfy the convergence condition (step S106). The convergence condition is, for example, the number of times the coefficient estimation and correction process are executed.

When the convergence condition is not satisfied (step S106: No), the process returns to step S104. After this, the coefficient estimation module 111 updates the linear regression equation with the coefficient corrected by the correction module 113, and then estimates again the coefficient of the updated linear regression equation (step S104). Next, the calculation module 112 updates the degree of influence with the product of the correction value, the coefficient of the updated linear regression equation, and the maximum value of the basis function corresponding to the coefficient of the updated linear regression equation. Then, the correction module 113 again corrects the coefficient of the updated linear regression equation based on the updated degree of influence (step S105). The information processing device 100 repeats the estimation of the coefficient, the calculation of the degree of influence, and the correction of the coefficient predetermined times.

When the convergence condition is satisfied (step S106: Yes), the output control module 103 calculates a performance evaluation index of the model (step S107). The performance evaluation index can be any index, and may include, for example, one or more of the following indices.
root mean square error (RMSE)
L0 norm
L1 norm
L2 norm

Next, the output control module 103 determines whether the learned model satisfies the convergence condition (step S108). The convergence condition in this case is, for example, the number of times the model learning process is executed. For example, the convergence condition is that the performance evaluation index calculated is greater than a predetermined evaluation threshold. When the convergence condition is not satisfied (step S108: No), the hyperparameter is updated (step S109), returning to step S104. The hyperparameter is, for example, λₙ to be used for the calculation of the threshold in Formula (6) and (7).

When the convergence condition is satisfied (step S108: Yes), the output control module 103 outputs the model (step S110), and ends the generation process.

The knowledge may be updatable. In this case, the estimation module 110 may acquire the updated knowledge in step S102 and update the correction value by using the updated knowledge.

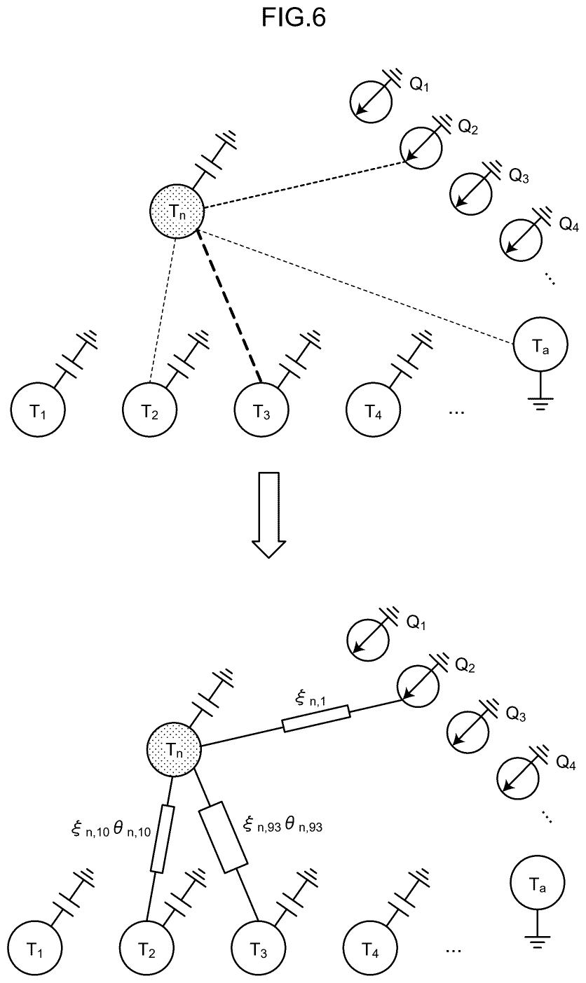

A specific example of the process according to the embodiment will be described. FIG. 6 is a diagram illustrating how coefficients of the regression equation for determining the temperature Tₙ at the target node n are estimated. The dashed lines included in the upper diagram of FIG. 6 correspond to the given knowledge. For example, two variables connected by the dashed line indicate variables that have a high degree of relationship.

The lower diagram of FIG. 6 illustrates an example of coefficients estimated by using the above-described knowledge. The lower diagram illustrates that, for example, for the temperature Tₙ, out of the temperature T (T₁, T₂, T₃, T₄, . . . Tₐ) and the calorific value Q (Q₁, Q₂, Q₃, Q₄, . . . ) at other nodes, the temperature T₂, the temperature T₃, and the calorific value Q₂ are selected as variables, and the corresponding coefficients are estimated.

Next, an example of how knowledge is provided will be described. The example in FIG. 4 includes knowledge denoting the relationship between the temperatures at different nodes. However, the relationship between the temperatures may vary, for example, depending on the individual's criteria, and it may not be possible to appropriately set the presence or absence of the relationship. In contrast, the relationship between the temperature at the node and the variables other than the temperature at the node can sometimes be set relatively easily. Examples of variables other than the temperature at the node include the calorific value of the node, the environmental temperature that is measured independently of the node, and the like.

As such, knowledge may be given only for the relationship between some variables for which the relationship can be appropriately set. The correction value α, for example, between 0 and 1 inclusive, is set for the coefficient corresponding to the variable to which knowledge is given. Note that for coefficients corresponding to variables to which no knowledge is given, the correction value α is set to 1, for example.

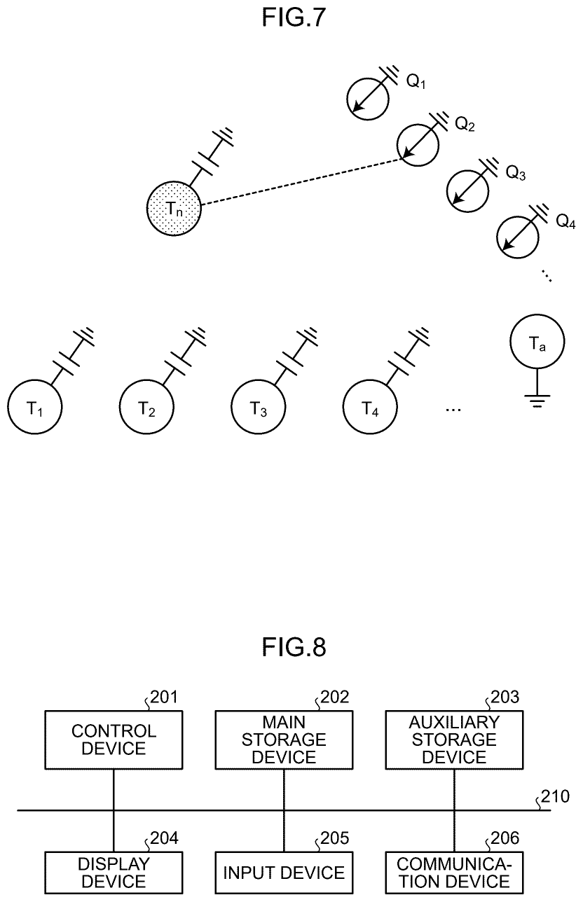

FIG. 7 is a diagram illustrating an example of knowledge given between some variables. In FIG. 7, for the temperature Tₙ at the node n, only knowledge of the relationship with the calorific value Q₂ is given. For example, an example of an approximate expression generated according to the present embodiment using the knowledge as illustrated in FIG. 7 and the time-series data as illustrated in FIG. 2 is denoted in Formula (9) below. Unlike Formula (3) generated by the conventional method, correct variables are selected in Formula (9).

$$\{ \begin{matrix}{\dot{T}}_{1 - 1} = … + 0.0016 {Q}_{1 - 1} \\ {\dot{T}}_{1 - 2} = … + 0.0016 {Q}_{1 - 2} \\ {\dot{T}}_{2 - 1} = … + 0.0016 {Q}_{2 - 2} \\ {\dot{T}}_{2 - 2} = … + 0.0016 {Q}_{2 - 2} \\ ⋮\end{matrix} \qquad ( 9 )$$

### Modified Example

Next, an example of executing the estimation of coefficients and the selection of variables together, as in the method TB, will be described.

In the modified example, for example, the estimation module 110 estimates the coefficients by optimizing a loss function that includes the regression equation and the regularization term. The estimation module 110 may use any regularization term that has been conventionally used. The following shows examples of the regularization term.
L1 norm of least absolute shrinkage and selection operator (Lasso): ∥β∥₁
L2 norm of ridge: ∥β∥₂²
L1+L2 norm of elastic net
Trace norm of trace lasso: ∥Xdiag(β)∥+
Norm of adaptive lasso: ∥β/β^{γ}˜∥₁
Norm of hypothesis transfer:

$$λ {\vert \vert β \vert \vert}_{{2}^{2}} + ( 1 - λ ) {\vert \vert β - β ∼ \vert \vert}_{{2}^{2}}$$

Norm of fused lasso:

$$λ {\vert \vert β \vert \vert}_{1} + ( 1 - λ ) \sum {\vert \vert {β}_{j} - {β}_{j - 1} \vert \vert}_{1}$$

The estimation module 110 of the modified example estimates the coefficients of the regression equation by correcting the regularization term with the correction value α and optimizing the loss function that includes the corrected regularization term. Formula (10) below shows an example of formula representing optimization of the loss function that includes the regularization term. Formula (10) is an example that includes the L1 norm as the regularization term.

$$\begin{matrix}β = {arg min}_{β} \{ \frac{1}{2 N} {‖ y - X β ‖}_{2}^{2} + λ {‖ αβ ‖}_{1} \} \\ = {arg min}_{β} \{ \frac{1}{2 N} {‖ y - X β ‖}_{2}^{2} + λ {\sum }_{n = 1}^{N} \vert {α}_{n} {β}_{n} \vert \}\end{matrix} \qquad ( 10 )$$

The formula in argmin of Formula (10) corresponds to the loss function. In the loss function, y−Xβ corresponds to the regression equation. In this regression equation, X corresponds to the input variable, y corresponds to the output variable, β (βₙ) corresponds to the coefficient, and αₙ corresponds to the correction value. λ is a hyperparameter.

αₙ takes a value, for example, between 0 and 1 inclusive. αₙ may be a continuous value or a discrete value such as (0, 0.3, 0.6, 1.0). The value of an may differ for each node n or may be common to the nodes. The coefficient βₙ corresponding to the variable xₙ is corrected with αₙ. This makes it easier for the variable xₙ with a large αₙ to be selected. Note that the value of the estimated coefficient βₙ itself is not corrected with the correction value αₙ.

In this way, the information processing device of the embodiment estimates the coefficients of the regression equation by using the correction values determined based on the knowledge obtained in advance. This allows further improvement in the precision of generating the model of physical phenomena.

Finally, an example of the hardware configuration of the information processing device 100 of the embodiment will be described. FIG. 8 is a diagram illustrating an example of the hardware configuration of the information processing device 100 of the embodiment.

The information processing device 100 of the embodiment includes a control device 201, a main storage device 202, an auxiliary storage device 203, a display device 204, an input device 205, and a communication device 206. The control device 201, the main storage device 202, the auxiliary storage device 203, the display device 204, the input device 205, and the communication device 206 are connected via a bus 210.

The control device 201 executes a program read from the auxiliary storage device 203 to the main storage device 202. The main storage device 202 is a memory such as a ROM and a RAM. The auxiliary storage device 203 is a hard disk drive (HDD), a memory card, and the like.

The display device 204 displays display information. The display device 204 is, for example, a liquid crystal display or the like. The input device 205 is an interface for operating the information processing device 100. The input device 205 is, for example, a keyboard, a mouse, or the like. When the information processing device 100 is a smart device, such as a smartphone and a tablet-type terminal, the display device 204 and the input device 205 are, for example, a touch panel.

The communication device 206 is an interface for communicating with other devices and the like.

The program to be executed by the information processing device 100 of the embodiment is a file in an installable or executable format, and is recorded in a computer-readable storage medium such as a CD-ROM, memory card, CD-R, and DVD, and is provided as a computer program product.

A configuration may be adopted such that the program to be executed by the information processing device 100 of the embodiment is stored on a computer connected to a network such as the Internet and is provided by downloading via the network. A configuration may be adopted such that the program to be executed by the information processing device 100 of the embodiment is provided via a network such as the Internet without downloading.

A configuration may be adopted such that the program of the information processing device 100 of the embodiment is provided by being incorporated into a ROM or the like in advance.

The program to be executed by the information processing device 100 of the embodiment has a modular configuration including functional blocks that can also be implemented by the program among functional blocks described above (FIG. 3). As actual hardware of each of the functional blocks, the control device 201 reads and executes the program from a storage medium, whereby each of the functional blocks is loaded on the main storage device 202. That is, each of the functional blocks is generated on the main storage device 202.

Note that part or all of the functional blocks described above may not be implemented by software, but may be implemented by hardware such as an integrated circuit (IC).

When implementing each function by using a plurality of processors, each processor may implement one of the functions, or may implement two or more of the functions.

The operational mode of the information processing device 100 of the embodiment may be arbitrary. The information processing device 100 of the embodiment may operate, for example, as a cloud system on a network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
at least one hardware processor configured to function as:
a regression equation generation module that generates a regression equation including a plurality of input variables and a plurality of coefficients respectively corresponding to the plurality of input variables to obtain one or more output variables; and
an estimation module that estimates the plurality of coefficients by using one or more correction values each of which corrects each of one or more target coefficients included in the plurality of coefficients, each of the correction values being determined based on knowledge regarding a relationship between an input variable corresponding to a target coefficient and an output variable.

2. The information processing device according to claim 1, wherein
the estimation module estimates the plurality of coefficients by optimizing a loss function that includes a regularization term corrected with the correction values.

3. The information processing device according to claim 1, wherein
the correction value is determined for each of the one or more target coefficients that are some of the plurality of coefficients.

4. The information processing device according to claim 1, wherein
the correction value is set to a larger value as a degree of the relationship between the input variable corresponding to the target coefficient and the output variable increases.

5. The information processing device according to claim 1, wherein
the input variables include a basis function represented by a plurality of nonlinear functions,
the estimation module includes:
a coefficient estimation module that estimates the plurality of coefficients;
a calculation module that calculates a degree of influence based on a first target coefficient among the one or more target coefficients, a representative value that is for a first basis function among one or more basis functions corresponding to the first target coefficient and that is of the first basis function in data used to estimate the plurality of coefficients, and the correction value; and
a correction module that corrects the plurality of coefficients by using the degree of influence.

6. The information processing device according to claim 5, wherein
the coefficient estimation module updates the regression equation with the coefficients corrected by the correction module, and further estimates coefficients of the updated regression equation,
the calculation module further calculates the degree of influence based on the one or more target coefficients included in the updated regression equation,
the correction module further corrects the coefficients of the updated linear regression equation based on the updated degree of influence, and
the estimation module repeats estimation of the coefficients, calculation of the degree of influence, and correction of the coefficients a predetermined number of times.

7. The information processing device according to claim 5, wherein
the correction module corrects the coefficients corresponding to the first basis function with the degree of influence equal to or less than a threshold to zero.

8. The information processing device according to claim 1, wherein
the hardware processor is configured to further function as an output control module that outputs the regression equation represented by the estimated coefficients.

9. The information processing device according to claim 1, wherein
the estimation module estimates the plurality of coefficients by a non-negative least squares method.

10. The information processing device according to claim 1, wherein
the regression equation represents a model of a thermal network.

11. An information processing method implemented by a computer of an information processing device, the information processing method comprising:
generating a regression equation including a plurality of input variables and a plurality of coefficients respectively corresponding to the plurality of input variables to obtain one or more output variables; and
estimating the plurality of coefficients by using one or more correction values each of which corrects each of one or more target coefficients included in the plurality of coefficients, each of the correction values being determined based on knowledge regarding a relationship between an input variable corresponding to a target coefficient and an output variable.

12. A computer program product having a non-transitory computer readable medium including instructions stored thereon, wherein the instructions, when executed by a computer, cause the computer to execute:
generating a regression equation including a plurality of input variables and a plurality of coefficients respectively corresponding to the plurality of input variables to obtain one or more output variables; and
estimating the plurality of coefficients by using one or more correction values each of which corrects each of one or more target coefficients included in the plurality of coefficients, each of the correction values being determined based on knowledge regarding a relationship between an input variable corresponding to a target coefficient and an output variable.
